(19) United States
(12) Patent Application Publication
(10) Pub. No.: US 2006/0262517 A1
(43) Pub. Date: Nov. 23, 2006

(54) Shoe with improved light pattern

(76) Inventors: Daniel M. Doerer, St. Louis, MO (US); Michael H. Ruckle, St. Louis, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/133,700

(22) Filed: May 20, 2005

(51) Int. Cl. F21V 33/00; A43B 23/00

(52) U.S. Cl. 362/103; 36/137

(57) ABSTRACT

A shoe having an outsole and an upper associated with the outsole and configured to cover a user's foot. The outsole and the upper together provide an exterior surface. A plurality of illuminating devices are located along an exterior surface of the shoe where they are exposed. The plurality of illuminating devices are placed along the exterior of the shoe to generally form an arrangement of illuminating devices around the exterior of the shoe. A source of electrical energy is connected to the light source for illuminating the illuminating devices upon detection of motion of the shoe. The source is configured to light the illuminating devices according to a predetermined sequence wherein the arrangement provides the illusion of a point of light moving around the shoe, with simultaneous illumination of adjacent illuminating devices, so that only two illuminating devices on a side of the shoe are simultaneously lit.

### FIELD OF THE INVENTION

The invention relates to shoes. More specifically, the invention relates to shoes having lights with an improved light display pattern.

### BACKGROUND OF THE INVENTION

Children have taken a liking to shoes having illumination of one type or another incorporated into them. Typically, the shoe contains light emitting diodes (LEDs) in its upper or along its sole and a battery and energizing circuitry in its heel. When the child, while walking or running, steps on the heel, the circuitry momentarily provides an electrical potential across the LED to illuminate it. Where the shoe contains multiple LEDs, the circuitry may illuminate them in a predetermined sequence. To a measure, the illuminated shoe represents a novelty, but when worn at night, it makes the wearer more visible, and thus provides the child with a measure of safety.

To this end, because the lights largely represent a novelty, lights that display in a pleasing or interesting pattern are most desirable.

### SUMMARY OF THE INVENTION

The present invention comprises a shoe having an outsole and an upper associated with the outsole so as to provide an exterior surface. A plurality of illuminating devices are located along an exterior surface of the shoe where they are exposed. The plurality of illuminating devices are placed along the exterior of the shoe to generally form an arrangement of illuminating devices around the exterior of the shoe. A source of electrical energy is connected to the light source for illuminating the illuminating devices upon detection of motion of the shoe. The source is configured to light the illuminating devices according to a predetermined sequence wherein the sequence provides the illusion of a point of light moving along and/or around the shoe through simultaneous illumination of illuminating devices.

### BRIEF DESCRIPTION OF THE DRAWINGS

FIG. 1 is a perspective view showing the toe and one side of an illuminated shoe constructed in accordance with and embodying the present invention;

FIG. 2 is a perspective view showing the toe and the opposite side of the illuminated shoe, with the shoe upper being partially broken away to show the interior of the shoe;

FIG. 3 is a timing diagram according to an embodiment of the present invention;

FIG. 4 is a timing diagram according to another embodiment of the present invention;

FIG. 5 is a timing diagram according to a further embodiment of the present invention;

FIG. 6 is a timing diagram according to an additional embodiment of the present invention;

FIG. 7 is a timing diagram according to another embodiment of the present invention; and

FIG. 8 is a timing diagram according to yet another embodiment of the present invention.

### DESCRIPTION OF THE PREFERRED EMBODIMENT

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

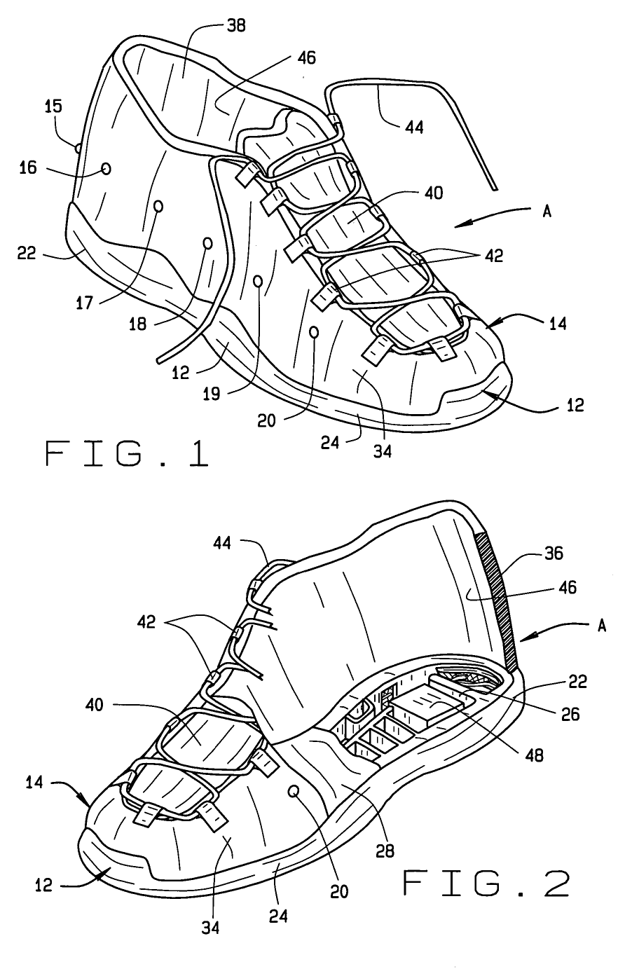

Referring now to the drawings, a shoe A (FIGS. 1 and 2) has an outsole 12 and a upper 14 which is attached to the outsole 12, the upper 14 being configured to receive and fit over the user's foot. The outsole 12 has several illuminating devices illustrated as 15, 16, 17, 18, 19, and 20 installed on it. These illuminating devices 15-20 momentarily cast illumination when the shoe A is subject to an impact, such as when the user brings the outsole 12 into contact with pavement or a floor. The illuminating devices 16-20 project outwardly from the side of the outsole 12 and, when illuminated, are highly visible. Illuminating device 15 projects from the rear of the outsole 12. Illuminating devices 16′-20′ (not shown) are provided on the opposite side (instep side) of the outsole 12 in corresponding locations to illuminating devices 16-20. Indeed, the illuminating devices are not only visible when viewed from directly on, but also when viewed at a considerable angle.

The outsole 12 is molded from an elastomer which gives it a good measure of flexibility and some resilience, yet enough stiffness to support the user without significant deformation. It includes a heel portion 22, which underlies the user's heel, and a foreportion 24, which underlies the rest of the user's foot, including the toes, ball and arch. The heel portion 22 contains a cavity 26 (FIG. 2) for housing an energizing unit to be described.

The outsole 12 has an insole 28 (FIG. 2) attached to it. Indeed, the insole 28 covers substantially the entire outsole 12 and provides the surface upon which the user's foot actually rests. The insole 28 also covers and completely closes the cavity 26 in the heel portion 22 of the outsole 12.

In FIGS. 1 and 2, the upper 14 has a vamp 34 which extends over the foreportion 24 of the outsole 12 and quarters 36 which extend along the heel portion 22 and forwardly to merge with the vamp 34. The quarters 36 aid in creating an opening 38 that receives the user's foot. Opening 38 extends forwardly into the vamp 34 where its front edge is defined by the rear edge of a tongue 40. Along the opening 38 the vamp 34 is provided with eyelets 42 through which a lace 44 passes. Finally, the upper 14 contains a liner 46 which lies along the inside surfaces of the vamp 34 and quarters 36, being attached to them. The vamp 34 and quarters 36 can be cut from leather, canvas or other suitable synthetic or man-made materials as known in the art, whereas the liner 46 is normally cut from cloth but can be made of other suitable synthetic or man made materials.

The upper 14 contains apertures in panels of the vamp 34 and in the quarters 36 that open outwardly, that is in the region of the vamp 34 and the quarter 36 that lie along the outside of the user's foot. The liner 46 lies behind each of the apertures, so the interior of the shoe A is not exposed through the apertures. The illuminating devices 15-20 and 16′-20′ fit into the space between the liner 46 and the vamp 34 or quarter so that the illuminating portion of the devices 15-20 and 16′-20′ extend through the apertures to be visible on the outside of the shoe A. The apertures thus allow the illuminating devices to be inserted through the upper 14.

The illuminating devices 15-20 and 16′-20′ are most preferably light emitting diodes (LEDs). The illuminating devices 15-20 and 16′-20′ have wires connected to them, and the wires lead to the cavity 26 in the outsole 12, passing between the upper 14 and the liner 46, so that they remain isolated from the user's foot.

The outsole cavity 26 contains a modular energizing unit 48 for momentarily impressing an electrical potential across the several illuminating devices 15-20 and 16′-20′, either in unison or sequentially, to illuminate the illuminating devices 15-20 and 16′-20′. This potential and the electrical current, which flows through the illuminating devices 15-20 and 16′-20′ as a consequence, derive from a small battery that forms part of the energizing unit 48. In addition, the energizing unit 48 has electrical circuitry that includes a motion-sensitive switch. Such switches are well known in the art. The switch may, for example, constitute nothing more than a small coil spring of numerous convolutions that is fastened firmly at one end and projects horizontally in a cantilevered manner over a contact plate, from which it is normally separated. However, when the spring is subjected to a vertically directed force, such as would derive from a walking or running impact imparted to the module, the spring is deflected against the contact. When this occurs, the circuitry momentarily places the illuminating devices 15-20 and 16′-20′ across an electrical potential that is ultimately derived from the battery. The potential causes current to pass through each illuminating device 15-20 and 16′-20′ and illuminate it. The circuitry in the energizing unit 48 can correspond to the circuitry disclosed in U.S. Pat. No. 4,848,009 issued to Nicholas A. Rodgers on Jul. 18, 1989, the contents of which are expressly incorporated herein by reference.

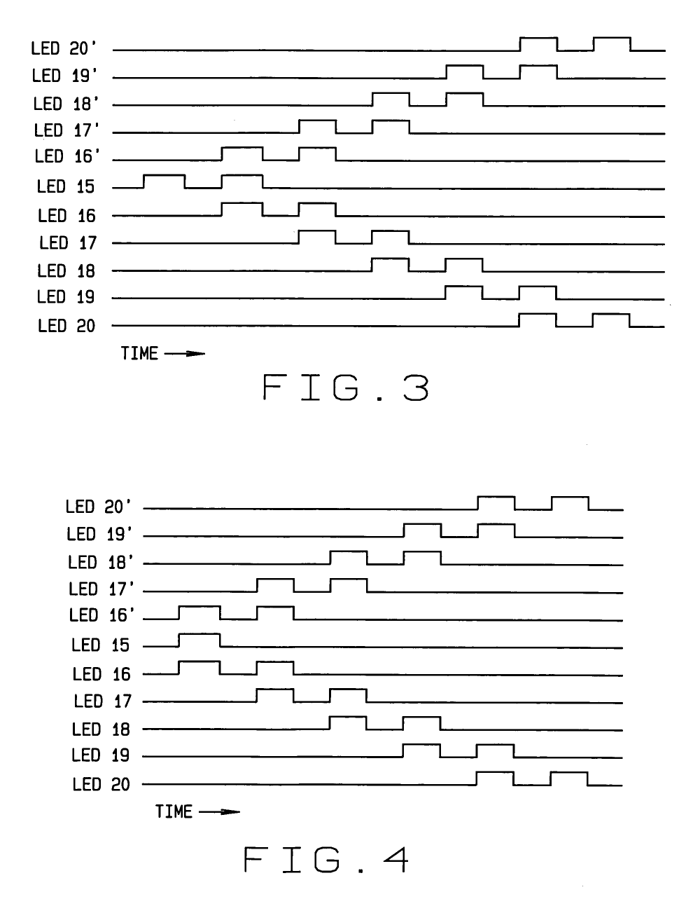

According to the present invention, the circuitry of unit 48 momentarily impresses on each illuminating device 15-20 and 16′-20′ an electrical potential of sufficient magnitude to illuminate the illuminating devices 15-20 and 16′-20′ only momentarily. The momentary burst of light is preferably of a specific sequence that provides the illusion of movement of the light around the shoe A. Specifically, the illuminating devices 15-20 and 16′-20′ are illuminated according to FIG. 3. In FIG. 3, illuminating devices 15-20 and 16′-20′ are sequentially lit such that at least two illuminating devices are lit at the same time except for the illuminating device 15, which is lit first by itself. Specifically, first, only illuminating device 15 is lit; then only illuminating devices 15, 16 and 16′ are lit. Next, only illuminating devices 16, 17, 16′ and 17′ are lit. After that, only illuminating devices 17, 18, 17′ and 18′ are lit. Then, only illuminating devices 18, 19, 18′ and 19′ are lit. Next, only illuminating devices 19, 20, 19′ and 20′ are lit. Finally, only illuminating devices 20 and 20′ are lit. In this manner, the shoe A gives the appearance of light moving from the rear to the front of the shoe A. The timing diagram of FIG. 3 could be reversed without departing from the scope of the present invention.

In an alternative embodiment of that shown in FIG. 3, the timing diagram of FIG. 4 is shortened to provide that at no point in the timing diagram are less than two illuminating devices illuminated on either side of the shoe. In that regard, in FIG. 4, first only illuminating devices 15, 16 and 16′ are lit. Next, only illuminating devices 16, 17, 16′ and 17′ are lit. Then, only illuminating devices 17, 18, 17′ and 18′ are lit. After that, only illuminating devices 18, 19, 18′ and 19′ are lit. Finally, only illuminating devices 19, 20, 19′ and 20′ are lit. In this manner, the shoe A gives the appearance of light moving from the rear to the front of the shoe A through a shortened sequence. It would be obvious to one of ordinary skill in the art that the timing diagram of FIG. 4 could be reversed without departing from the scope of the present invention to give the appearance of light moving from the front to the rear of the shoe.

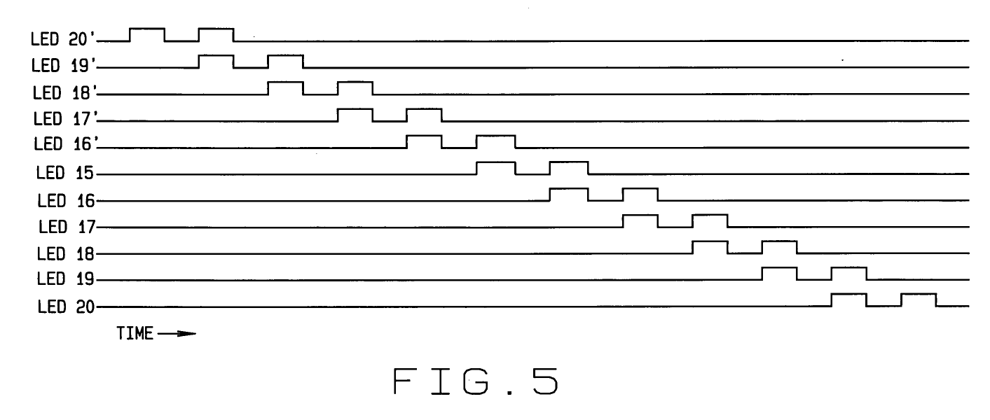

In another alternative embodiment shown in FIG. 5, light appears to be traveling around the shoe. Specifically, first only illuminating device 20′ is lit. Next, only illuminating devices 19′ and 20′ are lit. Then, only illuminating devices 18′ and 19′ are lit, followed by only illuminating devices 17′ and 18′ being lit. After that, only illuminating devices 16′ and 17′ are lit, followed by only illuminating devices 15 and 16′ being lit then followed by only illuminating devices 15 and 16 being lit. Next, only illuminating devices 16 and 17 are lit. Finally, only illuminating devices 17 and 18 are lit, followed by only illuminating devices 18 and 19 being lit, then only illuminating devices 19 and 20 being lit, and after that only illuminating device 20 being lit.

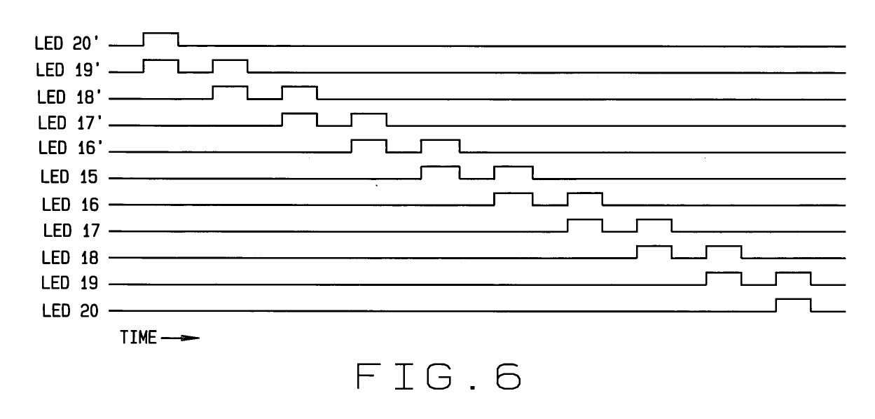

In a fourth alternative embodiment shown in FIG. 6, the timing sequence of FIG. 5 is modified such that fewer than two illuminating devices are never illuminated on the shoe at any given point. In this regard, first only illuminating devices 19′ and 20′ are lit. Next, only illuminating devices 18′ and 19′ are lit, followed by only illuminating devices 17′ and 18′ being lit. Then, only illuminating devices 16′ and 17′ are lit, followed by only illuminating devices 15 and 16′ being lit next followed again by only illuminating devices 15 and 16. After that, only illuminating devices 16 and 17 are lit. Finally, only illuminating devices 17 and 18 are lit, followed by only illuminating devices 18 and 19 being lit, then only illuminating devices 19 and 20 being lit.

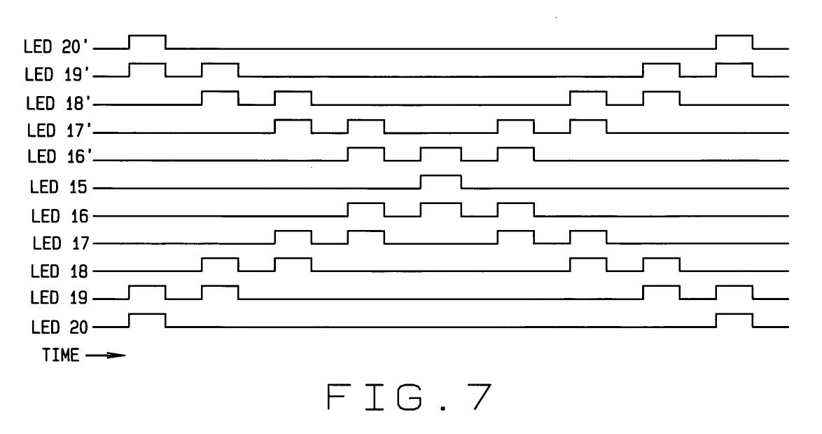

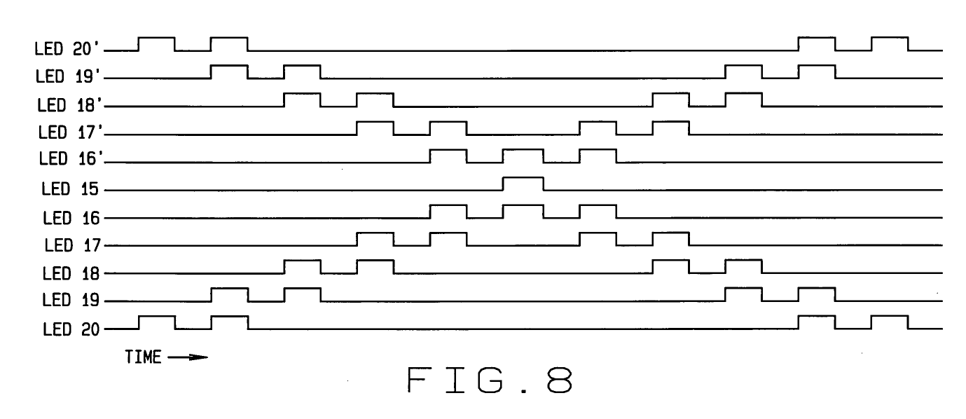

In a fifth alternative embodiment shown in FIG. 7, the illuminating devices are lit in a pattern that makes it appear that two points of light are traveling around the shoe in opposite directions. In that regard, first only illuminating devices 19, 20, 19′ and 20′ are lit, then only illuminating devices 18, 19, 18′ and 19′ are lit, next only illuminating devices 17, 18, 17′ and 18′ are lit, after which only illuminating devices 16, 17, 16′ and 17′ are lit, then only illuminating devices 15, 16 and 16′ are lit, thereafter only illuminating devices 16, 17, 16′ and 17′ are lit, then only illuminating devices 17, 18, 17′ and 18′ are lit, next only illuminating devices 18, 19, 18′ and 19′ are lit, and finally only illuminating devices 19, 20, 19′ and 20′ are lit. The timing diagram of FIG. 7 may also be modified to that of FIG. 8, wherein the diagram is begun and ended with only illuminating devices 20 and 20′ being lit.

The illumination devices can include elements that provide a cover about or around the LED, such as the diffusing element 42 depicted in U.S. Pat. No. 5,930,921 to Howard Sorofman, et al., issued on Aug. 3, 1999, the contents of which are expressly incorporated herein by reference. Any element covering the LED could very from being highly diffusing or providing little diffusion.

The illuminating devices 16 need not be confined to the upper 14 of the shoe A, but can be located along any exposed surface of the shoe A. This includes the side and end surfaces of the outsole, such as for example, in a way such as disclosed in U.S. Pat. No. 5,599,088 to Tseng Chien, issued on Feb. 4, 1997, the contents of which are expressly incorporated herein by reference. Many other ways of mounting the illuminating devices and covering them as known in the art can also be employed within the scope of the invention.

Moreover, illuminating devices 16′-20′ on the shoe instep may be omitted for cost savings. Finally, the number of illuminating devices may be selected for an appropriate compromise between cost and illuminating effect.

While the specific embodiments have been illustrated and described, numerous modifications come to mind without significantly departing from the spirit of the invention, and the scope of protection is only limited by the scope of the accompanying claims.

What is claimed is:

1. A shoe comprising:
an outsole and an upper associated with the outsole and configured to cover a user's foot, the outsole and the upper together providing an exterior surface;
a plurality of illuminating devices located along an exterior surface of the shoe where they are exposed, the plurality of illuminating devices being placed along the exterior of the shoe to generally form an arrangement of illuminating devices around the exterior of the shoe; and
a source of electrical energy connected to the illuminating devices for illuminating the illuminating devices upon detection of motion of the shoe, the source being configured to light the illuminating devices in a predetermined sequence of:
illuminating a first illuminating device in the arrangement of illuminating devices;
simultaneously illuminating an adjacent, second illuminating device in the arrangement of illuminating devices and the first illuminating device; and
continuing to illuminate next, successive illuminating devices in the arrangement of illuminating devices and extinguishing previous illuminating devices such that only two illuminating devices are simultaneously lit in the arrangement, until the last illuminating device in the arrangement is lit.

2. The shoe of claim 1 wherein a timing sequence for illuminating the illuminating devices comprises:
simultaneously illuminating a first illuminating device and an adjacent, second illuminating device in the arrangement of illuminating devices; and
continuing to illuminate next, successive illuminating devices in the arrangement of illuminating devices and extinguishing previous illuminating devices such that only two illuminating devices are simultaneously lit in the arrangement, until the last illuminating device in the arrangement is lit.

3. The shoe of claim 2 wherein the plurality of illuminating devices are placed along the exterior of right and left sides of the shoe to generally form an arrangement of illuminating devices along the right and left sides of the shoe.

4. The shoe of claim 1 wherein a timing sequence for illuminating the illuminating devices comprises:
illuminating a first illuminating device in the arrangement of illuminating devices;
simultaneously illuminating adjacent, second and third illuminating devices in the sequence of illuminating devices on either side of the first illuminating device and the first illuminating device; and
continuing to illuminate next, successive illuminating devices in the arrangement of illuminating devices and extinguishing previous illuminating devices such that only four illuminating devices are simultaneously lit in the sequence, until the last illuminating device in the sequence is lit.

5. The shoe of claim 1 wherein a timing sequence for illuminating the illuminating devices comprises:
simultaneously illuminating a first illuminating device and adjacent, second and third illuminating devices in the arrangement of illuminating devices on either side of the first illuminating device; and
continuing to illuminate next, successive illuminating devices in the arrangement of illuminating devices and extinguishing previous illuminating devices such that only four illuminating devices are simultaneously lit in the sequence, until the last illuminating device in the arrangement is lit.

6. The shoe of claim 1 wherein the timing sequence for illuminating of the arrangement of illuminating devices begins at the rear of the shoe, continues along one side of the shoe and terminates toward the front of the shoe.

7. The shoe of claim 1 wherein the timing sequence for illuminating of the arrangement of illuminating devices begins at the rear of the shoe, continues along both sides of the shoe and terminates toward the front of the shoe.

8. The shoe of claim 1 wherein the timing sequence for illuminating of the arrangement of illuminating devices begins at the rear of the shoe, continues along one side of the shoe, continues around the front of the shoe and along the opposite side of the shoe and terminates at the rear of the shoe.

9. The shoe of claim 1 wherein the timing sequence for illuminating of the sequence of illuminating devices begins at the rear of the shoe, continues along both sides of the shoe and ends at the front of the shoe.

10. The shoe of claim 1 wherein the timing sequence for illuminating of the arrangement of illuminating devices begins at the rear of the shoe and continues in two directions along opposite sides of the shoe, continues around the front of the shoe and along the opposite side of the shoe and terminates at the rear of the shoe.

11. A shoe comprising:
an outsole and an upper associated with the outsole and configured to cover a user's foot, the outsole and the upper together providing an exterior surface;
a plurality of illuminating devices located along an exterior surface of the shoe where they are exposed, the plurality of illuminating devices being placed along the exterior of the shoe to generally form an arrangement of illuminating devices around the exterior of the shoe; and
a source of electrical energy connected to the illuminating devices for illuminating the illuminating devices upon detection of motion of the shoe, the source being configured to light the illuminating devices according to a predetermined sequence wherein the sequence provides the illusion of a point of light moving around the shoe wherein a timing sequence for illuminating the illuminating devices comprises:
simultaneously illuminating a first illuminating device and an adjacent, second illuminating device in the arrangement of illuminating devices; and
continuing to illuminate next, successive illuminating devices in the arrangement of illuminating devices and extinguishing previous illuminating devices such that only two illuminating devices are simultaneously lit in the sequence, until the last illuminating device in the sequence is lit.

12. The shoe of claim 11 wherein the plurality of illuminating devices are placed along the exterior of right and left sides of the shoe to generally form a sequence of illuminating devices along the right and left sides of the shoe.

13. The shoe of claim 12 wherein timing sequence for illuminating of the sequence of illuminating devices begins at the rear of the shoe, continues along one side of the shoe and ends at the front of the shoe.

14. The shoe of claim 12 wherein the timing sequence for illuminating of the sequence of illuminating devices begins at the rear of the shoe, continues along both sides of the shoe and ends at the front of the shoe.

15. The shoe of claim 12 wherein the timing sequence for illuminating of the sequence of illuminating devices begins at the rear of the shoe, continues along one side of the shoe, continues around the front of the shoe and along the opposite side of the shoe and ends at the rear of the shoe.

16. The shoe of claim 12 wherein the timing sequence for illuminating of the sequence of illuminating devices begins at the rear of the shoe, continues along one side of the shoe, continues around the front of the shoe and along the opposite side of the shoe and ends at the rear of the shoe.

17. The shoe of claim 12 wherein the timing sequence for illuminating of the sequence of illuminating devices begins at the rear of the shoe and continues in two directions along opposite sides of the shoe, continues around the front of the shoe and along the opposite side of the shoe and ends at the rear of the shoe.

18. A shoe comprising:
an outsole and an upper attached to the outsole and configured to cover a user's foot, the outsole and the upper together providing an exterior surface;
a plurality of illuminating devices located along an exterior surface of the shoe where they are exposed, the plurality of illuminating device being placed along the exterior of the shoe to generally form a sequence of illuminating devices around the exterior of the shoe;
a source of electrical energy connected to the illuminating devices for illuminating the illuminating devices upon detection of motion of the shoe, the source being configured to light the illuminating devices according to a predetermined sequence wherein the sequence provides the illusion of a point of light moving around the shoe, wherein a timing sequence for illuminating the illuminating devices comprises:
simultaneously illuminating a first illuminating device and adjacent, second and third illuminating devices in the sequence of illuminating devices on either side of the first illuminating device; and
continuing to illuminate next, successive illuminating devices in the sequence of illuminating devices and extinguishing previous illuminating devices such that only four illuminating devices are simultaneously lit in the sequence, until the last illuminating device in the sequence is lit; and
wherein the timing sequence for illuminating of the sequence of illuminating devices begins at the rear of the shoe and continues in two directions along opposite sides of the shoe, continues around the front of the shoe and along the opposite side of the shoe and ends at the rear of the shoe.
